(19) United States
(12) Patent Application Publication
(10) Pub. No.: US 2003/0051147 A1
(43) Pub. Date: Mar. 13, 2003

(54) Authentication-selection system, and authentication system

(75) Inventors: Takuji Maeda, Tokyo (JP); Masahito Matsushita, Tokyo (JP); Kouichi Sasakawa, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/080,697

(22) Filed: Feb. 25, 2002

(30) Foreign Application Priority Data
Aug. 28, 2001 (JP) 2001-257794

(51) Int. Cl. H04L 9/00

(52) U.S. Cl. 713/186; 713/168

(57) ABSTRACT

An authentication-selection system includes an authentication-means selector 26 which selects one among a plurality of authentication and one or more combinations of the authentication, using at least one of authentication means for authenticating person. Preferably, a combination generator 24 for generating the one or more combinations of the authentication using at least one authentication means for authenticating person; and a calculator 25 for calculating authentication performance for each of the plurality of authentication and the one or more combinations of the authentication are further provided. An authentication system includes the above authentication-selection system and at least one authentication means 11 for authenticating person. Thereby, there is provided an authentication-selection system for selecting one among the plurality of authentication and the one or more combinations of the authentication satisfying target performance required for authentication.

### BACKGROUND OF THE INVENTION

1. Field of the Invention

The present invention relates to an authentication system for authenticating a person using authentication means.

2. Description of the Background There have been various kinds of methods for security protection of important confidential matters by limiting a number of persons accessible to the above matters, and for checking persons entering a specific room. For example, use of an IC card, or input of an ID, a password and so on have been used as a method for the above authentication. However, the IC card, the ID, the password, and so on are not suitably used for more strict security protection, as even other persons, except the registrants themselves, may use the above IC card, the ID, the password, and so on.

On the other hand, Japanese Laid-Open Patent Publication No. 2000-76450 discloses an authentication device using unique fingerprints for each person which other persons may not use. The authentication device verifies the combination of the kinds of input fingerprints, and the orders.

In the authentication method according to the above authentication device, a plurality of times of fingerprint inputs are performed and it is also decided whether the input order is correct or not, in order to improve the confidentiality of authentication with a fingerprint. However, only a plurality of times of fingerprint inputs are performed, and, then, the degree of authentication accuracy has not been understood, though the confidentiality of authentication may be improved by the above method. In other words, when a certain degree of authentication accuracy is required, it has not been possible to estimate how many times of the fingerprint inputs is required for securing the above required authentication accuracy.

### SUMMARY OF THE INVENTION

The object of the present invention is to provide an authentication system by which a person is authenticated, using authentication means satisfying a target performance necessary for the authentication.

In accordance with one aspect of the present invention, there is an authentication-selection system includes a storage device and an authentication-means selector. The storage device stores a target-performance required for authenticating a person. The authentication-means selector selects one among a plurality of authentication and one or more combinations of the authentication means satisfying the target-performance.

Preferably, the authentication-selection system may further include a combination generator and a calculator. The combination generator generates a plurality of authentication and one or more combinations of the authentication means. The calculator calculates authentication performance for each of the every plurality of authentication and the one or more combinations of the authentication means.

More preferably, the authentication-selection system may further include a target-performance setter and a limiting-condition setter. The target-performance setter sets the target performance. The limiting-condition setter sets limiting condition for authentication means.

In this case, the combination generator generates the plurality of authentication and the one or more combinations of the authentication means, based on the limiting condition. Moreover the authentication-means selector selects one among the plurality of authentication and the one or more combinations of the authentication means, based on the limiting condition.

At least one limiting condition may include at least one of the some items. The items may include a plurality of kinds of the plurality of authentication means, priority in the plurality of kinds of the plurality of authentication means, combination of the authentication, priority in the combinations, a number of the plurality of authentication for combination, priority in the numbers of the authentication in a combination, and a number of candidate combinations.

The authentication-selection system may include a performance storage device and a log-analyzer. The performance storage device may store the authentication performance of the authentication means. The log-analyzer may analyze the log data, which is authentication result by the authentication means, and may reflect the analysis results on the authentication performance of the authentication means.

Preferably, the performance storage device may store authentication performance for each registrant.

The authentication performance of the authentication means may include at least one of the some items. The items may include a probability density function of matching score indicating degree of coincidence between input data and registration data in a case where person is registrant. In addition, the items may include a numerical table, a probability distribution, and parameters in the case of approximation by a normal distribution.

In another aspect of the present invention, there is an authentication system includes the above-mentioned authentication-selection and at least one of the plurality of authentication means. The above-mentioned authentication-selection system may select one among the plurality of authentication and the one or more combinations of the authentication. The at least one of the plurality of authentication means may authenticate person by verification of input data of person with registration data.

In this case, the step of authenticating person is performed by the selected authentication or the selected combination of the authentication.

In a further aspect of the present invention, there is a selecting method for selecting one among a plurality of authentication and one or more combinations of the authentication. The method includes the steps of generating one or more combinations of the authentication, calculating and storing authentication performance, and selecting one among the plurality of authentication and the one or more combinations of the authentication. The step of generating one or more combinations of the authentication is performed by the authentication means. The step of calculating and storing authentication performance are performed regarding with each of the plurality of authentication and the one or more combinations of the authentication. The step of selecting one among the plurality of authentication and the one or more combinations of the authentication may meet target performance required for authentication.

In a still further aspect of the present invention, there is an authentication method includes the steps of generating one or more combinations of the authentication, calculating and storing authentication performance, selecting one among the plurality of authentication and the one or more combinations of the authentication, and authenticating a person. The step of generating one or more combinations of the authentication is performed by the authentication means. The step of calculating and storing authentication performance are performed for each of the plurality of authentication and the one or more combination of the authentication. The step of selecting one among the plurality of authentication and the one or more combinations of the authentication may meet target performance required for authentication. The step of authenticating a person after verification of input data of person with registration data is performed by the authentication, or the combination of the authentication.

In a yet further aspect of the present invention, there is an authentication-selection program executed on a computer. The program includes the steps of the above selecting method for selecting one among a plurality of authentication and one or more combinations of the authentication. Preferably, the above authentication-selection program may be included in a computer-readable recording medium.

In a yet further aspect of the present invention, there is an authentication program executed on a computer. Preferably, the program may include the steps of the above authentication method. More preferably, the above authentication-selection program may be included in a computer-readable recording medium.

### BRIEF DESCRIPTION OF THE DRAWINGS

The present invention will become readily understood from the following description of preferred embodiment thereof made with reference to the accompanying drawings, in which like parts are designated by like reference numeral and in which:

FIG. 1 is a block diagram of an authentication-selection system and an authentication system according to the first embodiment of the present invention;

FIG. 2 is a flow chart of authentication-selection according to the first embodiment of the present invention;

FIG. 3 is a flow chart of calculation of authentication performance of each authentication means;

FIG. 4A is a graph showing relations between FRR and FAR, which are authentication performance of authentication means, and thresholds;

FIG. 4B is a graph showing a distribution of matching score for identical persons, and one for other persons, which are obtained by differentiation of FRR and FAR in FIG. 4A, respectively;

FIG. 5A is a graph showing relations between set thresholds and false rejection of authentication (FR) with regard to a distribution of matching score for identical persons;

FIG. 5B is a graph showing relations between set thresholds and false acceptance of authentication (FA) with regard to a distribution of matching score for other persons;

FIG. 6 is a flow chart showing details of a procedure 102 for calculation and storage of combined authentication-performance of each combination in FIG. 2;

FIG. 7 is a flow chart showing details of a procedure 127 in FIG. 6;

FIG. 8 is a flow chart showing details of a procedure 104 in FIG. 2;

FIG. 9A is a table showing relations between combinations of a plurality of authentication and thresholds of each authentication means satisfying target performance;

FIG. 9B is a table in which the above combinations in FIG. 9A are rearranged according to a limiting condition;

FIG. 10 is a flow chart of an authentication method with an authentication system according to the first embodiment of the present invention;

FIG. 11 is a block diagram of an authentication-selection system and an authentication system according to the second embodiment of the present invention;

FIG. 12 is a flow chart of a procedure for reflection of log data, in which persons are authenticated to be as registrants themselves, among all the log data on a distribution of matching score for identical persons in an authentication-selection system according to the second embodiment of the present invention;

FIG. 13 is a flow chart of a procedure for reflection of log data, in which person is authenticated to be as registrants, among all the log data on a distribution of matching score for other persons in an authentication-selection system according to the second embodiment of the present invention;

FIG. 14 is a table for limiting conditions in which priority in the kinds of authentication means is provided in an authentication-selection system according to the fourth embodiment of the present invention;

FIG. 15 is a table showing combinations which are rearranged according to the limiting conditions in FIG. 14; and

FIG. 16 is a table for limiting conditions in which priority in the methods for combining a plurality of authentication is provided in an authentication-selection system according to the fifth embodiment of the present invention.

### DETAILED DESCRIPTION OF THE INVENTION

Hereinafter, an authentication-selection system, and an authentication system according to embodiments of the present invention will be described, referring to attached drawings.

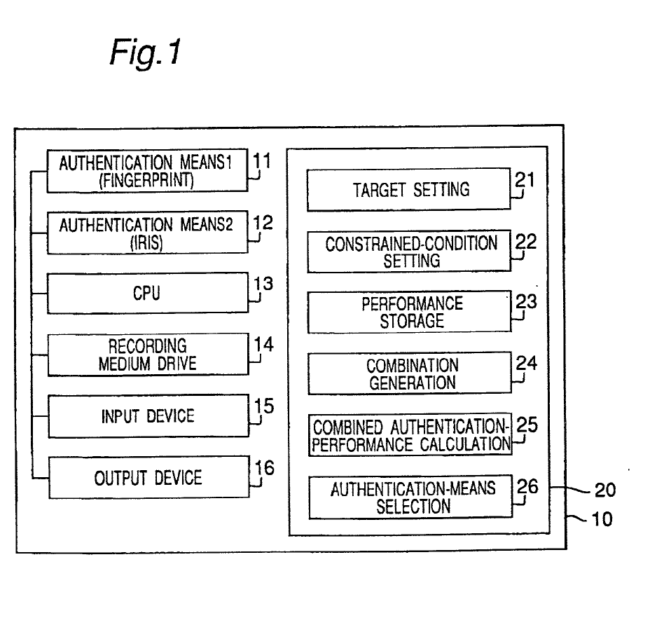

An authentication-selection system, and an authentication-system according to the first embodiment of the present invention will be described. The above authentication-selection system is configured to comprise, as shown in a block diagram of FIG. 1: a target-performance setter 21 for setting a target performance as a program read into a memory 20 of a computer; a limiting-condition setter 22 for setting limiting conditions for authentication means to be selected; a performance storage device 23 for storage of the authentication performance of the authentication means; a combination generator 24 for generation of combinations of a plurality of authentication using authentication means, based on the above limiting conditions; a combined authentication-performance calculator 25 for calculation of authentication performance for each combination of a plurality of authentication; and an authentication-means selector 26 for selection of a combination of a plurality of authentication, based on the above limiting conditions. In the above authentication-selection system, a person is authenticated by a combination of a plurality of authentication using the authentication means selected in the authentication-means selector 26. Thereby, a person may be authenticated by a combination of a plurality of authentication using the authentication means, which satisfies the target performance, and, moreover, satisfying the limiting conditions. Here, the above authentication system is not limited to the above components, and may comprise other components. Further, the above program read into the memory 20 may be recorded on recording medium such as a hard disk. In addition, the above target-performance setter 21; the above limiting-condition setter 22; the above performance storage device 23; the above combination generator 24; the above combined authentication-performance calculator 25; and the above authentication-means selector 26 may be realized not as a program, but as hardware-like means. Here, an authentication means I (fingerprint) 11 and an authentication means 2 (iris) 12 are used as authentication means for authentication of a person, though the above means is not a component of the above authentication-selection system. And, a CPU 13; a recording medium drive 14 for reading a program stored in a recording medium; an input device 15; an output device 16; the memory 20, and so on may be comprised as hardware for realizing the functions of the above software.

Here, the above authentication means 11, 12 will be described. A person is authenticated by the above authentication means 11, 12. The above “authentication” is an authentication procedure by which it is decided, for example, by verification of input data and registration data of a person whether the person is a registrant himself. Here, the above “authentication” may be authentication procedures other than the above one by verification. Further, authentication means, which is independently of living bodies, such as passwords, and IC cards may be also used as authentication means, other than authentication means for authentication by physical characteristics or actions, which are called as physiological information such as a fingerprint, a face, a voice, an iris, a palms and a signature, of each person. Preferable authentication means is the one by which the authentication is performed using the above physiological information such as a fingerprint, a face, a voice, an iris, a palm, and a signature. In the case of authentication using the above physiological information, “impersonation” of a registrant by another person caused by appropriation of a password or an IC card may be prevented. Here, “one authentication, or a combination of a plurality of authentication using authentication means” only requires at least one authentication using at least one authentication means, and is not limited to a combination of a plurality of authentication using a plurality of authentication means. Moreover, authentication using the same authentication means may be combined two or more times. In addition, each combination of a plurality of authentication may use a linear sum, and a weighting linear sum and so on, other than logical operations such as AND, OR, and NOT.

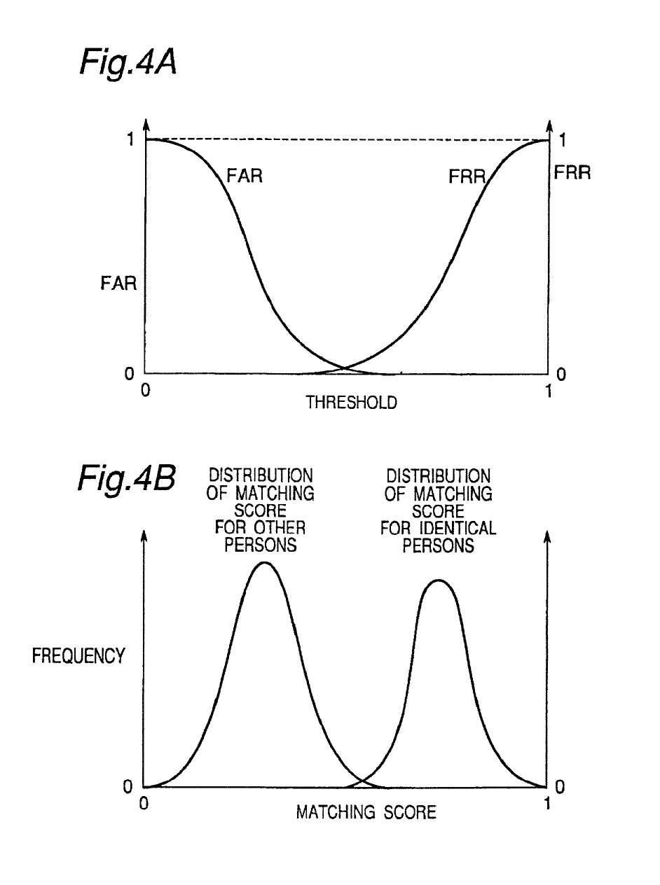

Then, the authentication performance of the authentication means will be described. In the authentication means for authentication according to the physiological information such as a fingerprint and an iris, a value of matching score indicating a degree of coincidence between registration data and input data is usually obtained, and, then, whether the above matching score exceeds a certain threshold or not decides whether a person is the identical person himself. The authentication performance of the authentication means is expressed, for example, by a false rejection rate (hereinafter called as FRR) which is a ratio of false rejection (hereinafter called as FR) by which a person, who is the registrant himself, is authenticated to be as another person who is not the registrant himself; and by a false acceptance rate (hereinafter called as FAR) which is a ratio of false acceptance (hereinafter called as FA) by which a person, who is another person being not the registrant himself (hereinafter, called as “another person”) is authenticated to be as the registrant himself. Here, there is caused FA where a person who is one of registrants himself is authenticated to be as another registrant himself, when there are a plurality of registrants. The above FRR and FAR are expressed as a function of thresholds, as they change according to the set threshold, as shown in FIG. 4A. And, there is a trade-off between the FRR and the FAR, as shown in FIG. 4A. That is, there is a character by which one of them is increased, and the other is decreased. In addition, FIG. 4B is a graph showing frequencies for each matching score respectively with regard to a matching score for identical persons when persons are registrants themselves, and that for other persons when persons are other persons being not the registrants themselves. The results after differentiation of FRR and FAR in FIG. 4A with regard to the threshold (matching score) correspond to a distribution of the matching score for identical persons, and that for other persons, respectively, as shown in FIG. 4B. By contrast to the above description, the results after integration of the distribution of the matching score for identical persons, and that for other persons, which are shown in FIG. 4B, with regard to the matching score correspond to the FRR and the FAR shown in FIG. 4A, respectively. Thereby, authentication performance of the authentication means may be stored in the form of any one of data in FIG. 4A or FIG. 4B. Here, the above authentication performance may be defined by other methods, other than the above ones.

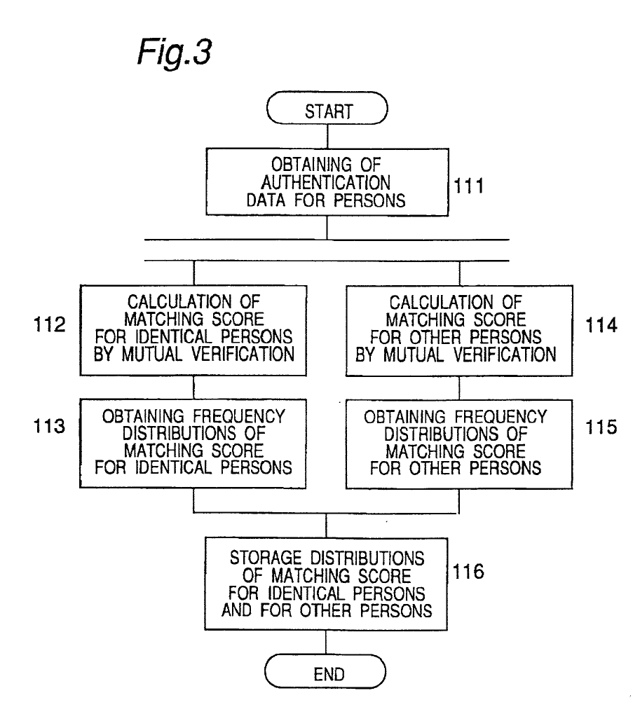

When there are few actual input data for verification accumulated, for example, in the case of an initial state where the authentication system starts operations, the characteristics of authentication performance provided by a sensor vendor of the using authentication means are used as the authentication performance of single authentication means. However, it is preferable to obtain the performance of the single authentication means, using actual input data according to the following procedures. The calculation of the authentication performance of each single authentication means is previously performed before actual authentication according to the following procedures, as shown in a flow chart of FIG. 3.

(1) The registration data of registrants input from the input device 15 are previously registered by a system administrator in a recording medium such as a hard disk after receiving the above data with the CPU 13.

(2) Then, input data of the person are received from each authentication means 11, 12 with the CPU 13 (step 111). Here, the following procedures are separately performed for input data of persons who are the registrants themselves, and for those, among all the input data, of persons who are mutually other persons.

(3-1) In the first place, processing procedures of the input data for a case where persons are the registrants themselves are shown. In this case, a matching score for identical persons is calculated by verification with the CPU 13 among the input data for each verification of the same registrant himself among all the input data (112).

(4-1) A probability density function for a frequency distribution of the matching score for identical persons is made with the CPU 13 (113). Here, the probability density function is used as an expression of the distribution of the matching score, but the above expression is not limited to the above one, and, for example, parameters such as the average and the variance in the case of approximation with a standard distribution function such as the probability distribution and the regular distribution may be used for the above expression.

(3-2) Then, processing procedures of the input data for a case where persons are mutually other persons. In this case, a matching score for other persons is calculated by verification with the CPU 13 among the input data for other persons among all the input data (114).

(4-2) A probability density function for a frequency distribution of the matching score for other persons is made with the CPU 13 (115). Here, even in the above case, the probability density function is used as an expression of the distribution of the matching score, but the expression is not limited to the above one as described above, and, for example, parameters such as the average and the variance in the case of approximation with a standard distribution function such as the probability distribution and the regular distribution may be used for the above expression.

(5) A distribution of the matching score for identical persons, and a distribution of the matching score for other persons are stored in the performance storage device 23, respectively (116).

For example, the distribution of the matching score for identical persons, and that for other persons, which are shown in FIG. 4B, may be obtained by the above procedures.

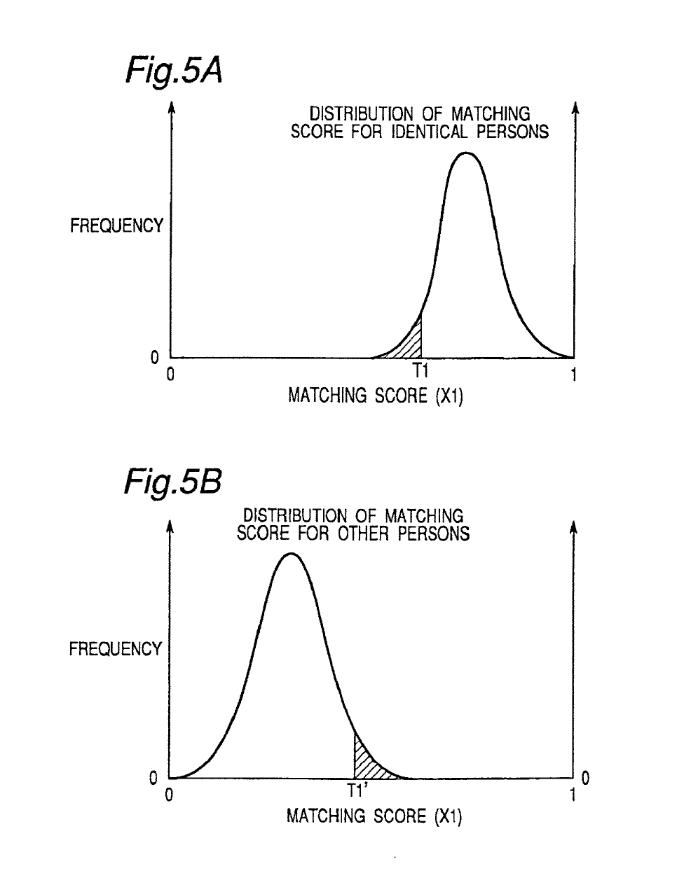

Then, relations between set thresholds and FRR in a distribution of the matching score for identical persons shown in FIG. 4B will be described, using FIG. 5A. When a threshold T1 is set to a score x1 of verification for a person, as shown in FIG. 5A, there is, in a shaded part where the matching score x1 is lower than the threshold T1, caused FR, where the person being the registrant himself is authenticated to be as another person being not the registrant himself. A ratio of the above shaded part to the whole distribution of the matching score for identical persons is FRR. Similarly, relations between set thresholds and FAR in the distribution of the matching score for other persons shown in FIG. 4B will be described, using FIG. 5B. When a threshold T1′ is set to a score x1 of verification for a person as shown in FIG. 5B, there is, in a shaded part where the matching score x1 is higher than the threshold T1′caused FA, where the person who is other persons being not the registrant himself is authenticated to be as the registrant himself. Here, there is caused FA where a person who is a registrant himself is authenticated by mistake to be as another registrant himself, when there are a plurality of registrants. A ratio of the above shaded part to the whole distribution of the matching score for other persons is FAR. Here, the thresholds T1, T1′ are configured to be different from each other for convenience of description, by which the shaded parts are clearly shown, but, actually, FRR and FAR are calculated for the same threshold, respectively.

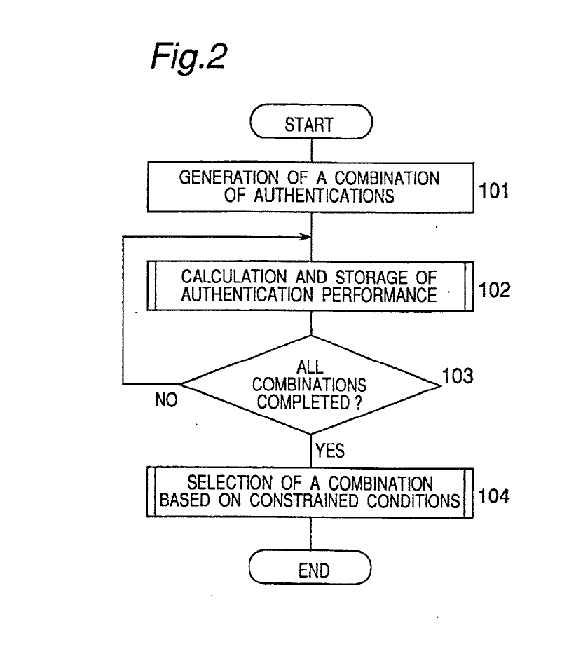

The authentication operations in the present authentication system are performed according to the following procedures shown in a flow chart of FIG. 2. Here, with regard to the use of hardware, a CPU, a memory, a recording medium drive and a recording medium, and so on, which comprise general computers may be used.

(1) A system administrator previously sets target performance such as a ratio (FAR), by which a person who is other persons being not the registrant himself is authenticated by mistake to be the registrant himself, in the target-performance setter 21, and limiting conditions as conditions for selection of a combination of a plurality of authentication are previously set in the limiting-condition setter 22. In this case, with regard to the use of the hardware, the CPU 13 of the computer receives the target performance and limiting conditions, which are input by the system administrator through the input device 15, and records the received ones in the recording medium such as a hard disk, respectively.

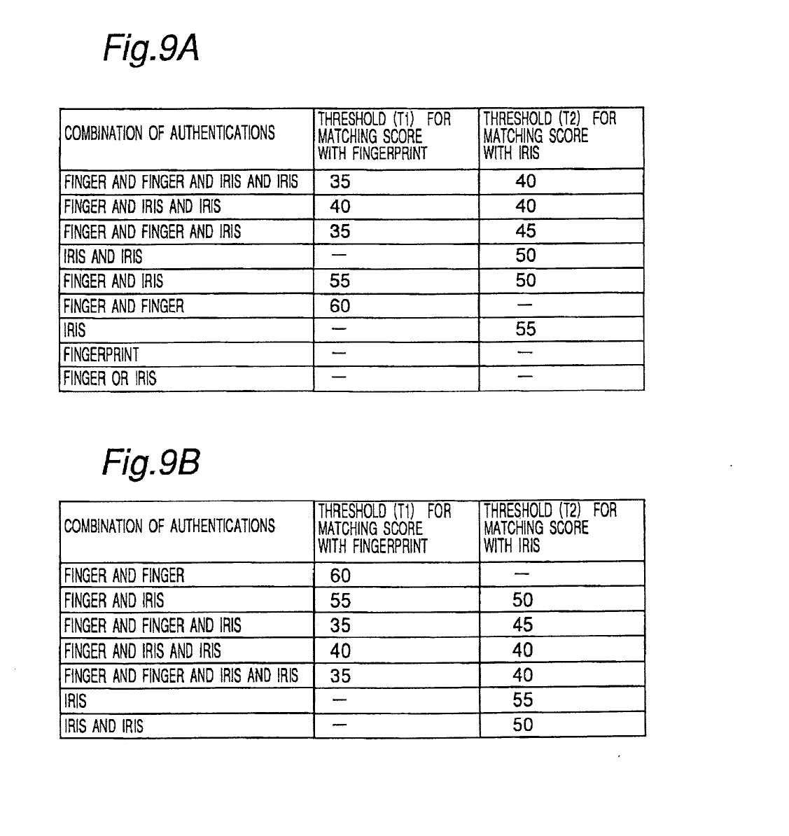

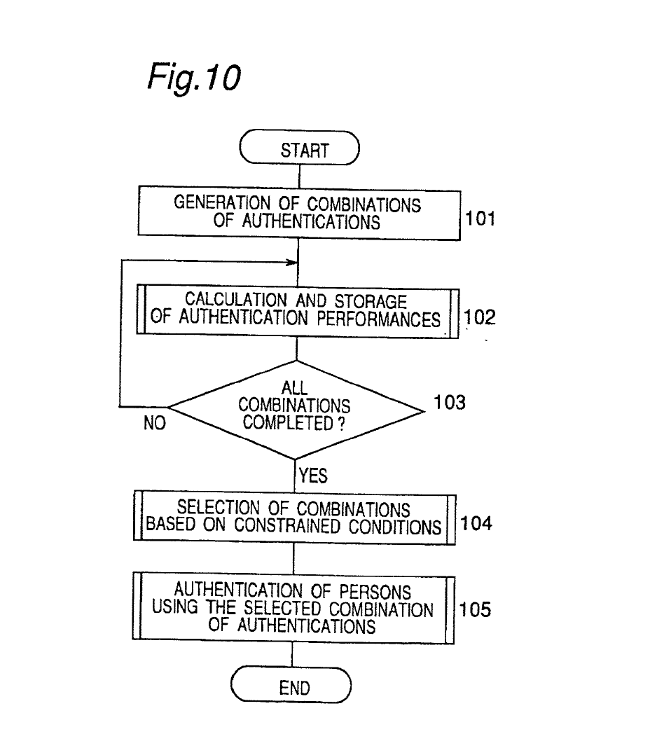

(2) Then, an authentication, or a combination of the authentication using authentication means is generated in the combination generator 24, based on the limiting conditions set in the limiting-condition setter 22 (101). In this case, with regard to the use of the hardware, the CPU 13 reads the limiting conditions, which are recorded in the recording medium; generates one authentication or a combination of authentication; and records the generated one in the recording medium such as a hard disk, respectively. The one authentication or a combination of authentication which is generated in the above case, is shown in the left column of FIG. 9A.

(3) In addition, the authentication performance for each combination of authentication are calculated in the combined authentication-performance calculator 25, and the above authentication performance for each combination are recorded in the performance storage device 23 (103). In this case, with regard to the use of the hardware, the CPU 13 calculates the authentication performance for each combination of authentication, and records the calculated ones in the recording medium, respectively.

(4) Then, it is decided in the CPU 13 (103) whether the authentication performance has been calculated or not for all the authentication and all the combinations of a plurality of authentication. Here, when calculation has not been performed for all the combinations, the procedures 102 are executed again.

(5) When the above calculation and storage have been completed for all authentication and all combinations of a plurality of authentication, one authentication or a combination of authentication is selected from all authentication and all combinations of a plurality of authentication, which satisfy the target performance, based on the limiting conditions in the authentication-means selector 26 (104). Here, the CPU 13 selects one authentication or a combination of authentication with regard to the use of the hardware.

By the above procedures, one authentication or a combination of a plurality of authentication, which satisfies the target performance, may be selected. And, authentication of a person may be performed by the selected authentication or the selected combination of authentication, while securing the target performance. Here, the target performance may be previously set for each room requiring the authentication, respectively, for example, when authentication of an identical person himself, based on the biometrics such as a fingerprint and a face, is performed at entrance into and exit out of a room. In the above case, selection of authentication means is performed, when a person selects a room which the above person desires to enter.

Then, each procedure in the above flow chart will be described. In the first place, a procedure for setting of target performance in the target-performance setter 21 will be described. With regard to setting of the target performance, high target performance may be set in the target-performance setter 21 at authentication for a case where authentication with high accuracy is required, for example, in the case of opening and closing of a door for entrance into and exit out of a room in very important facilities. On the other hand, suitable target performance may be set there for the above authentication at logging on a computer where authentication with medium accuracy is required. In one of the previous examples, a ratio of FAR by which other persons is authenticated by mistake to be as the registrant himself is required to be low at entrance into and exit out of a room in very important facilities, even if a ratio of FRR, by which the registrant himself is not authenticated to be as the registrant himself, is high. In this case, a system administrator sets the target performance, for example, as (FRR, FAR)=(3.0%, 0.001%). On the other hand, the system side sets the target performance, for example, as (FRR, FAR)=(0.1%, 0.1%), if greater importance is attached to the convenience with less importance to the security at logging on a computer.

Then, a procedure for setting of limiting conditions for a combination of authentication selected in the limiting-condition setter 22 will be described. Here, the limiting conditions mean the following ones at selection of a combination of authentication: the kind and the priority of authentication means used; the maximum number of combinations of a plurality of authentication using a plurality of authentication means; moreover, a method for combining the plurality of authentication and the priority for the above authentication, and so on. For example, it may be set as limiting conditions in the case of a door in important facilities that candidates for the authentication means are configured to be a fingerprint and an iris; the maximum number of combinations is four; and a combination method is AND. And, it may be set as limiting conditions in the case of logging on a computer that candidates for the authentication means are configured to be a fingerprint, a face, and a voice; the maximum number of combinations is three; and a combination method is AND, OR, weighting linear sum, and so on.

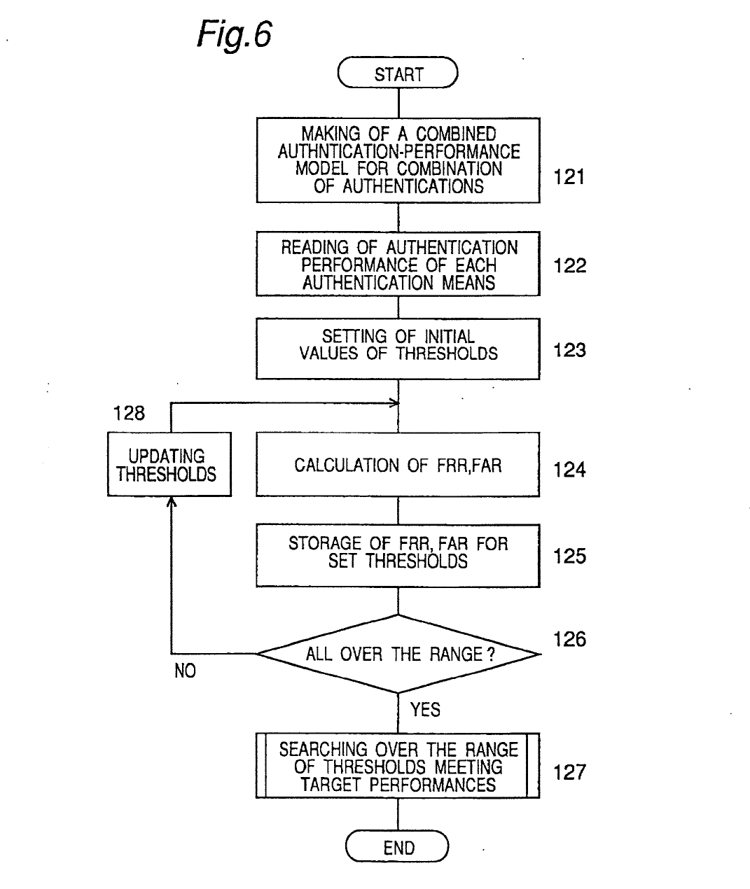

Then, a procedure 102 for calculation and storage of the combined authentication-performance of each combination in FIG. 2 will be described, using a flow chart of FIG. 6.

(1) In the first place, the combined authentication-models of combinations of the authentication using the authentication means are made with the CPU 13 (121). Here, the above procedure 121 will be described later.

(2) Subsequently, the authentication performance of each authentication means are read from the performance storage device 23 (122). With regard to the use of the hardware, the authentication performance of each authentication means are read from the recording medium.

(3) Initial values of thresholds T1, T2 for matching score x1, x2 of each authentication means are set (123). For example, when the range of the matching score is set between 0 and 100, the above initial values may be set as (T1, T2)=(0, 0).

(4) The authentication performances (FRR, FAR) are calculated, based on the set thresholds T1, T2 (124). With regard to the use of the hardware, the above authentication performances are calculated with the CPU 13.

(5) The combined authentication-performance based on the set thresholds T1, T2 are stored (125). With regard to the use of the hardware, the above authentication performances are stored in the recording medium.

(6) It is decided with the CPU 13 whether setting of thresholds T1, T2 has been completed for all over the range or not (126). When the setting of thresholds has not been completed for the above range, the above thresholds are updated (128), and the combined authentication-performance is calculated after returning to the procedure 124. The updating of the above thresholds may be performed, for example, by increasing any one of the thresholds one by one. And, the step sizes may be set according to the accuracy of the matching score obtained by each authentication means. The step sizes may be changed, for example, so that the above sizes are 0.1 when the accuracy of the matching score is the first place of decimals; and the above sizes are 0.01 when the above accuracy is the second place of decimals.

(7) The range of the thresholds satisfying the target performance is searched with the CPU 13, after setting of the thresholds has been completed for all over the range (127). The above procedure will be described later.

By the above procedures, the authentication performance of each combination satisfying the target performance may be calculated and stored.

Here, combinations in the relations shown in FIG. 9A are rearranged by the authentication-means selector in decreasing order of the priority according to the following condition, and a combination like one shown in FIG. 9B is selected as a final combination of authentication, when there is as a limiting condition the above condition, for example, that priority is given to the fingerprint with regard to the kind of authentication means, and a combination with a smaller number of combinations of a plurality of authentication using authentication means- is given priority. Thereby, a combination of authentication satisfying the above limiting conditions may be selected among a plurality of authentication and one or more combinations of the authentication satisfying the target performance. Here, only a set of the threshold (T1) for the matching score of the fingerprint and the threshold (T2) for the matching score of the iris is shown in FIG. 9 for simplification. However, there are some actual cases where there may be, over a predetermined range, other combinations as combinations of thresholds (T1, T2) to meet the target performance, other than the above combination. And, there are many combinations and they may be used, when a predetermined step size is set.

Then, a procedure in the above FIG. 6 will be described as one example where a combination of authentication using authentication means is “weighting linear sum of the fingerprint and the iris”.

(1) In the first place, the authentication performance of each authentication means is read. In the above example, a probability density function f1 (x1) of the matching score of an identical person with a fingerprint as authentication means; a probability density function g1 (x1) of the distribution of matching score for other persons and a probability density function f2 (x2) of the distribution of the matching score for the identical persons with an iris; and a probability density function g2 (x2) of the distribution of the matching score for other persons are read from the performance storage device 23. with regard to the use of the hardware, the above functions are read from the recording medium. Here, 1 and 2 of the subscripts mean a fingerprint and an iris as authentication means, respectively, and X1 and x2 indicate the matching score with a fingerprint and an iris as authentication means, respectively.

(2) A combined authentication performance model is made for the combination of authentication “weighting linear sum of a fingerprint and an iris.” In the first place, a new variable z corresponding to the weighting linear sum shown in the following formula is set.

z=weightsum(x1−T1, x2−T2)=w1(x1−T1)+w2(x2−T2) (1)

It is decided by the above variable z that a person is the registrant himself when the above variable is 0 or a positive value in the combination of authentication, and a person is other persons when the above variable is a minus value. And, the function of weightsum ( ) forming the variable z is a function performing calculation of the linear sum by multiplication of each argument by weighting coefficients, respectively, and w1 and w2 are weighting coefficients for the degree of authentication for a fingerprint x1 and that for an iris x2, respectively. The above w1 and w2 are parameters representing the degree of dependence of authentication on each authentication means.

Then, a probability density function with a variable of z for a case where a person is the registrant himself is written as F (z, T1, T2), and that for a case where the person is other persons is expressed as G (z, T1, T2). When the authentication results with each authentication means are independent each other, the probability density function of z in the formula (1) may be expressed by the following formulae (2), (3), respectively, as the above function may be expressed by the product of each probability density function.

$$\begin{matrix}F ( z , T1 , T2 ) = {\int }_{- ∞}^{+ ∞} f1 ( {x}^{′} 1 ) f2 ( {x}^{′} 2 ) ⅆ {x}^{′} 1 = {\int }_{- ∞}^{+ ∞} f1 ( {x}^{′} 1 ) f2 ( ( z - w1 \cdot {x}^{′} 1 ) / w2 ) ⅆ {x}^{′} 1 & ( 2 ) \\ G ( z , T1 , T2 ) = {\int }_{- ∞}^{+ ∞} g1 ( {x}^{′} 1 ) g2 ( {x}^{′} 2 ) ⅆ {x}^{′} 1 = {\int }_{- ∞}^{+ ∞} g1 ( {x}^{′} 1 ) g2 ( ( z - w1 \cdot {x}^{′} 1 ) / w2 ) ⅆ {x}^{′} 1 & ( 3 )\end{matrix}$$

Here, variable transformation of x′1=x1−T1, and X′2×2−T2 is performed in the formulae (2), (3), and the above formulae is expressed as a function of x′1, x′2, respectively. Moreover, correlation coefficients and so on may be considered for the configuration when there is a predetermined correlation among each authentication result, though it has been assumed in the present description that the authentication results with each authentication means are independent each other.

It is assumed to be decided by the variable z set as shown in the above formula (1) that a person is the registrant himself when the above variable is 0 or a positive value, and the above person is other persons when the above variable is a minus value. Thereby, a ratio of FRR by which a person, who is the registrant himself, is not the registrant himself and a ratio of FAR by which a person, who is other persons, is the registrant himself are expressed, in the above procedure 124 of FIG. 6, by the following formulae (4), (5), using F (z, T1, T2), and G (z, T1, T2).

$$\begin{matrix}FRR ( T1 , T2 ) = {\int }_{- ∞}^{0} F ( z , T1 , T2 ) ⅆ z & ( 4 ) \\ FAR ( T1 , T2 ) = {\int }_{0}^{+ ∞} G ( z , T1 , T2 ) ⅆ z & ( 5 )\end{matrix}$$

The probability density function F (z, T1, T2) of z for the registrant himself, and the probability density function G (z, T1, T2) of z for other persons may be determined by the above formulae (4), (5), when the variable z is set according to the combined authentication method, as described above. Then, the combined authentication-performance model of FRR may be made, based on the condition that F (z, T1, T2) becomes negative; and that of FAR may be made, based on the condition that G (z, T1, T2) becomes positive.

Subsequently, “AND authentication of a fingerprint and an iris” will be described. In this case, as the above authentication is an AND calculation, a person is authenticated as the registrant himself, only when authentication of the registrant himself is performed both with a fingerprint as authentication means, and with irises. In this case, the above variable, which decides whether a person is the registrant himself, is expressed by the following formula (6). That is, in the case of the AND authentication, the combined authentication-performance model may be made by substitution of the above formula (6) for the formula (1) at the above weighting-linear-sum authentication.

z=min(x1−T1, x2−T2) (6)

Here, min ( ) is a function for obtaining the minimum value of the arguments. In a similar manner to hat of the above case, it is decided that a person is the registrant himself when the variable z expressed by the formula (6) becomes 0 or a positive value; and that the person is other persons when the above variable z becomes a negative value. Accordingly, a case (FR) where a person, who is the registrant himself, is authenticated by mistake to be not the registrant himself is generated when at least one of the matching score for the fingerprint and the iris does not exceed each threshold T1, T2. On the other hand, a case (FA) where a person, who is other persons, is authenticated by mistake to be the registrant himself is generated when both of the matching score for the fingerprint and the iris exceed each threshold T1, T2. Here, when there are a plurality of the registrants, there is a case (FA) where a person, who is one of the registrants, is authenticated by mistake to be another registrant.

In addition, “OR authentication of a fingerprint and an iris” will be described. In this case, as the above authentication is an OR calculation, a person is authenticated as the registrant himself, when authentication of the registrant himself is performed with the fingerprint as authentication means, or with the iris. In this case, the above variable, which decides whether a person is the registrant himself, is expressed by the following formula (7). That is, in the case of the OR authentication, the combined authentication-performance model may be made by substitution of the above formula (7) for the formula (1) at the above weighting-linear-sum authentication.

z=max(x1−T1,x2−T2) (7)

Here, max ( ) is a function for obtaining the maximum value of the arguments. In a similar manner to that of the above case, it is decided that a person is the registrant himself when the variable z expressed by the formula (7) becomes 0 or a positive value; and that the above person is other persons when the above variable z becomes a negative value. Accordingly, a case (FR) where a person, who is the registrant himself, is authenticated by mistake to be not the registrant himself is generated when neither of the matching score for the fingerprint and the iris exceed each threshold T1, T2. On the other hand, a case (FA) where a person, who is other persons, is authenticated by mistake to be the registrant himself is generated when at least one of the matching score for the fingerprint and the iris exceed each threshold T1, T2. Here, when there are a plurality of the registrants, there is a case (FA) where a person, who is one of the registrants, is authenticated by mistake to be another registrant. Moreover, the combined authentication-performance model may be made by changing the definition of the variable z shown in the formula (1) even in other logical calculations and so on, and other combined authentication methods other than the above ones.

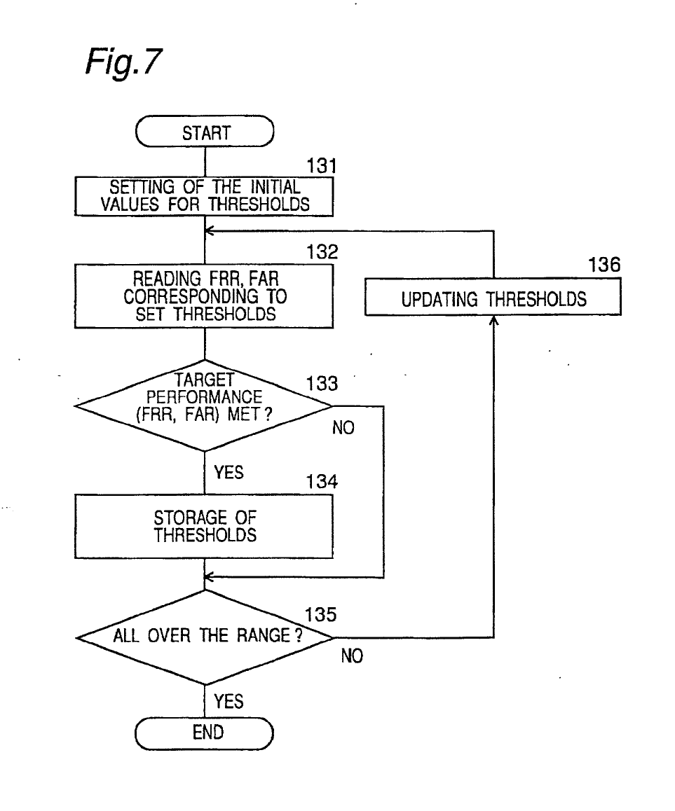

Then, the above procedure 127 in FIG. 6 will be described, using a flowchart in FIG. 7.

(1) In the first place, an initial value of a threshold is set (131). Setting an initial value of the above threshold is performed in a similar manner to that of the procedure 123 in the above FIG. 6.

(2) A combined authentication performance (FRR, FAR) corresponding to the set threshold is read from a recording medium (132).

(3) It is decided whether the read authentication-performance satisfying a target performance (FRR, FAR)(133). For example, when (FRR, FAR)=(3.0%, 0.001%) is set as a target performance in a combination of fingerprints and irises, it is decided by comparison between authentication performances (FRR, FAR), which have been read corresponding to the set thresholds T1, T2, and each value of the above target performances whether the above read authentication performances are satisfying the above target performances with the CPU 13, respectively.

(4) When it is decided that the value of the authentication performance based on the thresholds set in the procedure 133 meets the target performance, the above thresholds in that case are stored in a recording medium (134). On the other hand, when it is decided with the CPU 13 that the value of the authentication performance based on the thresholds set in the procedure 133 does not meet the target performance, the procedure 134 is jumped to the following procedure 135.

(5) Then, it is decided with the CPU 13 whether the setting of the thresholds has been completed for all over the range (135). When the above setting has been completed for the above range, the setting terminates.

(6) On the other hand, the thresholds are updated (136) for returning to the procedure 132, when there is, in the procedure 135, a range where the setting of the thresholds has not been completed.

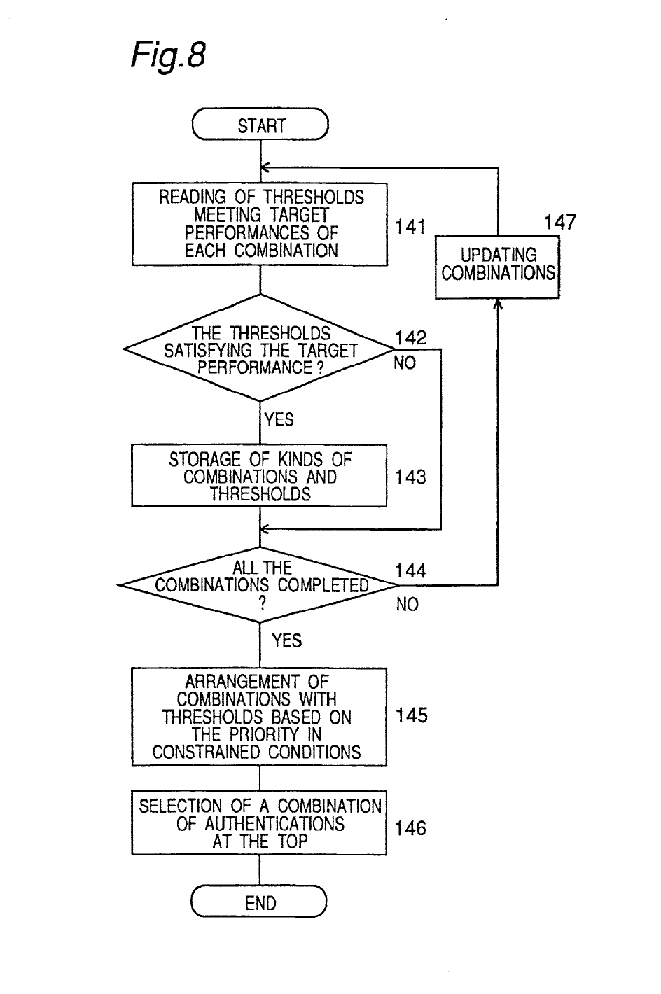

In addition, the procedure 104 for selection of a combination of the authentication based on limiting conditions among one or more combinations of the authentication satisfying the target performance in FIG. 2 will be described, using FIG. 8, and FIGS. 9A and 9B.

(1) The thresholds satisfying the target performance are read from a recording medium for each combination of authentication generated based on the limiting conditions (141). For example, they are combinations of combinations of a plurality of authentication and thresholds satisfying the target performance as shown in a table of FIG. 9A.

(2) It is decided with the CPU 13 whether there is a threshold satisfying the target performance or not (142).

(3) In the procedure 142, the kind of a combination of authentication, and a threshold are stored in the recording medium (143), when there is a threshold satisfying the target performance. On the other hand, the procedure 143 is bypathed, when there is no threshold satisfying the target performance in the procedure 142.

(4) It is decided with the CPU 13 whether all the combinations have been read or not (144). When there is a combination which has not been read, the object combination is updated to the next one (147) for moving to the procedure 141.

(5) On the other hand, the combinations where there are thresholds satisfying the target performance are arranged in order of the priority in the limiting conditions (145), when it is decided with the CPU 13 that all the combinations have been read in the procedure 144. For example, related combinations among the combinations listed in FIG. 9A are arranged as shown in FIG. 9B, when high priority for a case where the fingerprint is used as authentication means is a limiting condition.

(6) A combination of authentication at the head of the arrangement is selected with the CPU 13 (146). Here, the above selection of a combination of authentication is not limited to a case where the arrangement is performed according to a single limiting condition, and the above selection may be performed after arrangement according to a plurality of limiting conditions.

And, even in the case of other authentication means, similar combined authentication-performance models may be applied only by substitution of probability density functions of other authentication means for f1( ), and f2 ( ), though the fingerprint and the iris have been listed as examples of authentication means in the above authentication-selection system. Even when the number of combined authentication is equal to or larger than three, similar models may be applied only by sequential increase of each probability density function, that is, f1 ( ), f2 ( ), and f3 ( ).

In addition, though the fingerprint, the iris, and so on have been listed as examples of authentication means in the above first embodiment, various kinds of authentication means may be used without limit to the above examples. And, though the maximum number of combined authentication using authentication means has been four as a listed example, a desired number may be set without limiting to the above figure four. In addition, though the weighting linear sum, the AND calculation, and the OR calculation have been listed as an example of a method for combination of authentication, various kinds of calculation methods may be used without limiting to the above examples.

And, a program for selection of authentication executing the above authentication-selection system on a computer comprises the following procedure as shown in FIG. 2.

(1) A target performance, which is input from the input device 15 by a system administrator, such as a ratio (FRR), by which a registrant himself is authenticated by mistake to be as not the registrant himself, is previously received with a computer for storage in a recording medium. And limiting conditions as conditions for selection of combinations of a plurality of authentication, which is input from the input device 15 by a system administrator is previously received for storage in a recording medium.

(2) Then, combinations of a plurality of authentication are generated with the CPU 13 and so on, based on the set limiting conditions (101).

(3) In addition, authentication performance for each combination is calculated with the CPU 13 for storage of the above authentication performance for each combination in a recording medium and son (103).

(4) It is decided with the CPU 13 whether the calculation for the authentication performance has been completed for all the combinations or not (103). Here, when the calculation has not been performed for all the combinations, the procedure 102 is executed again.

(5) The combinations of a plurality of authentication are selected from the above combinations of a plurality of authentication with the CPU 13, based on the limiting conditions, when the above calculation and storage have been completed for all the combinations (104).

By the above procedures, the above authentication-selection system is executed on a computer for selection of combinations of a plurality of authentication satisfying the target performance, and authentication of a person may be performed with securing the target performance.

In addition, the above program for selection of authentication may be stored in a recording medium which may read the above program with a computer. As described above, the portability may be provided by storage in the recording medium which may read programs with a computer and the above authentication-selection system may be easily operated. Moreover, it is possible easily to execute the above program at a remote place, as the above authentication program may be transferred through an electronic communication channel.

Here, a magnetic recording medium such as a flexible disk, and a hard disk; an optical recording medium such as a CD-ROM (compact disc read-only memory), a CD-R (CD Recordable), a CD-RW (CD ReWritable), and a DVD (Digital Versatile Disk); an magneto-optical recording medium such as an MO (Magneto Optical disk) and an MD (Magnetic Disk); and a semiconductor recording medium such as an EEPROM (Electrically Erasable Programmable Read-Only Memory), a DRAM (Dynamic Random access Memory), and a flash memory may be used as the above recording medium which may read programs with a computer. The above programs for selection of authentication stored in the above recording media are read with a reader for the recording media, and are executed on a computer.

Then, the above authentication system will be described. The authentication system comprises as shown in a block diagram of FIG. 1: the above authentication-selection system; authentication means 1 (fingerprint) 11; and authentication means 2 (iris) 12 for authentication of a person. And, the above authentication system further comprises: a CPU 13; a recording medium drive 14 for reading programs stored in the above recording medium; an input device 15; an output unit 16; a memory 20; and so on. Here, the above authentication system may include other components without limiting to the above components. The authentication-selection system which is a component of the above authentication system is configured to realize its functions through the CPU 13 of hardware and so on as a program read on the memory 20, as shown in the above description. The above authentication system performs authentication of a person, based on one authentication or a combination of authentication using authentication means selected by the authentication-selection system, and using the above authentication means 11, 12. Thereby, a person may be authenticated by a combination of authentication using authentication means satisfying the target performance, and satisfying the limiting conditions.

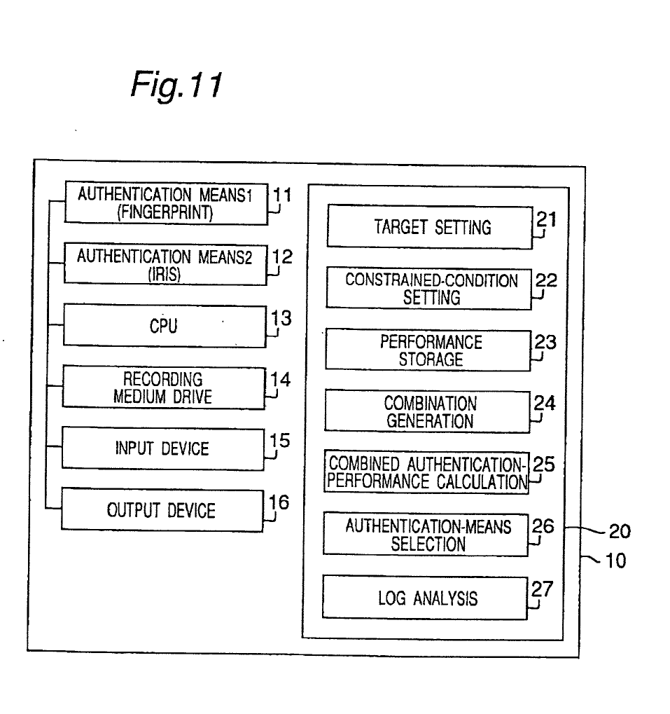

Then, an authentication method in the above authentication system will be described, using a flow chart in FIG. 11. The authentication method in the above authentication system includes procedures for the authentication-selection method according to the first embodiment. Therefore, the above authentication method has the same procedures till the procedure 104 as those of the authentication method shown in FIG. 2. In addition, a person is authenticated, using one authentication or a combination of a plurality of authentication using the selected authentication means, at the procedure 105 after the above procedure 104 (105).

And, the authentication program executing the above authentication method on a computer comprises the following procedures as shown in FIG. 11.

(1) Target performance, which is input from the input device 15 by a system administrator, such as a ratio (FRR), by which a registrant himself is authenticated by mistake to be as not the registrant himself, are previously received with a computer for storage in a recording medium. And limiting conditions as conditions for selection of combinations of a plurality of authentication, which are input from the input device 15 by a system administrator, are previously received for storage in the recording medium.

(2) Then, combinations of a plurality of authentication are generated with the CPU 13 and so on, based on the set limiting conditions (101).

(3) In addition, authentication performance for each combination is calculated with the CPU 13 for storage of the above authentication performance for each combination in a recording medium and so on (103).

(4) It is decided with the CPU 13 whether the calculation for the authentication performance has been completed for all the combinations or not (103). Here, when the calculation has not been performed for alt the combinations, the procedure 102 is executed again.

(5) The combinations of a plurality of authentication are selected from the above combinations of a plurality of authentication with the CPU 13, based on the limiting conditions, when the above calculation and storage have been completed for all the combinations (104).

(6) A person is authenticated by the selected combination of authentication (105).

By the above procedures, the above authentication system is executed on a computer for selection of combinations of a plurality of authentication satisfying the target performance, and authentication of a person may be performed with securing the target performance.

In addition, the above authentication program may be stored in a recording medium which may read the above program with a computer. As described above, the portability may be provided by storage in the recording medium which may read programs with a computer and the above authentication system may be easily operated. Moreover, it is possible easily to execute the above authentication program at a remote place, as the above program may be transferred through an electronic communication channel.

Here, a magnetic recording medium such as a flexible disk, and a hard disk; an optical recording medium such as a CD-ROM, a CD-R, a CD-RW, and a DVD; an magneto-optical recording medium such as an MO and an MD; and a semiconductor recording medium such as an EEPROM, a DRAM, and a flash memory may be used as the above recording medium which may read programs with a computer. The authentication programs stored in the above recording media are read with a reader for the recording media, and are executed on a computer.

An authentication-selection system, and an authentication system according to the second embodiment of the present invention will be described. In the first place, the authentication-selection system will be described. The present authentication-selection system and that of the first embodiment are different in provision of a log-analyzer 27, as shown in a memory 20 of FIG. 11, for analysis of log data accumulated in the course of the actual authentication. In the above log-analyzer 27, actual authentication results may be dynamically reflected on the authentication performance of each authentication means. Here, the log-analyzer 27 is realized by a program executed on a CPU 13.

With regard to the authentication performances (FRR, FAR) of each authentication means 11, 12 which are previously stored in the performance storage device 23, the authentication-selection system analyzes log data, which are obtained at actual authentication; and updates the above authentication performances of each authentication means. For example, when a fingerprint is used in a certain authentication as authentication means, input data at verification are retained as the log data. The log-analyzer 27 classifies the retained input data at verification into a case where persons are authenticated to be as the registrants themselves, and a case where persons are authenticated to be as other persons. Subsequently, a distribution of the matching score for identical persons which are based on mutual verification between data for registrants themselves, and a distribution of the matching score between data for other persons which are based on mutual verification between other persons are calculated. As, actual authentication results with each authentication means are stored at every authentication as described above, the existing authentication performance of each authentication means may be updated after statistical processing of the above stored results. Then, authentication may be selected by reflection of actual authentication results on the authentication performance of each authentication means, based on real performance of more actual authentication.

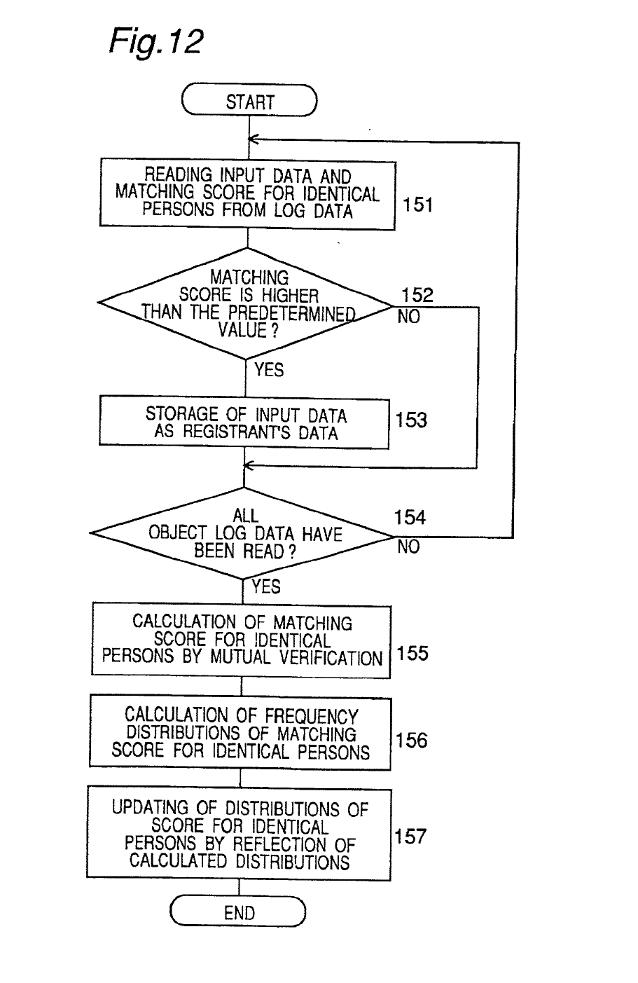

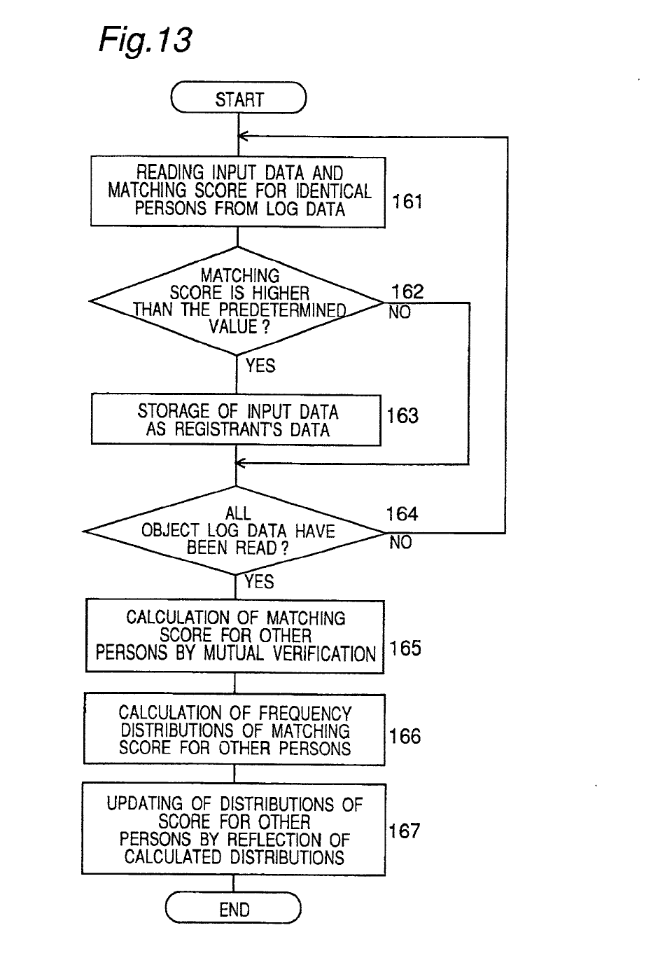

Details of procedures for reflection of the log data, which are analyzed, on the authentication performance of each authentication means will be described later, using flow charts of FIGS. 12, 13. In the first place, a case where the log data in which persons are authenticated to be as registrants themselves are reflected on the distribution of matching score for identical persons will be described, using FIG. 12.

(1) Input data and matching score, among the log data, in the case of authentication in which persons are authenticated to be as the registrants themselves are read from a recording medium one by one (151).

(2) It is decided with a CPU 13 (152) whether the above matching score are equal to or higher than a predetermined threshold for data reflection.

(3) The input data are stored in the recording medium (153) as data for the registrants themselves, when the matching score are equal to or higher than the predetermined threshold for reflection in the above procedure 152. When the matching score are lower than the predetermined threshold in the above procedure 152, the above input data are assumed not to be used for the reflection. In this case, it is preferable to use as data for the reflection only data the matching score of which exceed the above threshold for data reflection after setting of a threshold for the data reflection which is higher than the threshold for identification of identical persons. Thereby, the reliability of the data reflection may be improved.

(4) Then, it is decided with the CPU 13 (154) whether all the object log data have been read. If there are log data which have not been read, the process is returned to the procedure 151 for reading.

(5) The matching score for identical persons are calculated (155) after mutual verification every registrant with the CPU 13 among each input data where persons are authenticated to be registrants themselves.

(6) A frequency distribution of matching score for identical persons based on the log data is calculated (156).

(7) The distribution of the matching score for identical persons based on the log data are reflected on the existing distribution of matching score for identical persons with regard to all the registrants, and the above existing one is updated (157). With regard to use of hardware, the distribution of matching score for identical persons based on the above log data is added to the distribution of the matching score for the identical persons read from the recording medium, and the above read distribution is updated. Thereby, the reflection on a FRR, which is integration of the probability density function of the matching score for identical persons, may be also realized.

Then, a case where the log data in which persons are to be as registrants themselves are reflected on the distribution of matching score for other persons will be described, using FIG. 13.

(1) Collation data and matching score, among the log data, in the case of authentication in which persons are authenticated to be as the registrants themselves are read from a recording medium one by one (161).

(2) It is decided with a CPU 13 (162) whether the matching score are equal to or higher than a predetermined threshold for data reflection.

(3) In the above procedure 162, the input data are stored in the recording medium (163) as data for the registrants themselves, when the matching score are equal to or higher than the predetermined threshold for reflection. When the matching score are lower than the predetermined threshold in the above procedure 162, the input data are assumed not to be used for the reflection. In this case, it is preferable to use as data for the reflection only data the matching scores of which are equal to or higher than the above threshold for data reflection after setting of a threshold for the data reflection which is higher than the threshold for identification of identical persons. Thereby, the reliability of the data reflection may be improved.

(4) Then, it is decided with the CPU 13 (164) whether all the object log data have been read. If there are log data which have not been read, the process is returned to the procedure 161 for reading.

(5) With regard to input data where persons are authenticated to be registrants themselves, the matching scores for other persons are calculated (165) after mutual verification with the CPU 13 among mutually different input data for other persons.

(6) A frequency distribution of matching score for other persons based on the log data is calculated (166).

(7) The distribution of the matching score for other persons based on the log data are reflected on the existing distribution of matching score for other persons with regard to all the registrants, and the above existing one are updated (167). With regard to use of hardware, it is configured that the distribution of matching score for other persons based on the above log data is added to the distribution of the matching score for other persons read from the recording medium, and the above read distribution is updated. Thereby, the reflection on a FAR which is integration of the probability density function of the matching score for other persons may be also realized.

Here, the reflection based on the above log analysis may be performed, whenever log data are increased, or when predetermined log data are accumulated. And, the above reflection may be performed at a predetermined time interval, for example, once a day. In addition, extraction of the input data from the log data may be performed for log data which are recorded after the previous processing. And, the log data which are mutually verified may be only new ones or data including old ones.

Then, the authentication system will be described. The above authentication system is different from that of the first embodiment in provision of the log-analyzer 27 of the memory 20 as shown in FIG. 11 in a similar manner to the difference of the above authentication-selection system. And, authentication means 11, 12 are provided as hardware for execution of the above authentication-selection system on a computer as well as the authentication system according to the first embodiment, and, at the same time, the CPU 13, the recording medium drive 14, the input device 15, and the output device 16 are included.

An authentication-selection system according to the third embodiment of the present invention will be described. A point of differences between the present authentication-selection system and the authentication-selection systems according to the first and second embodiments, in which the authentication performance of each authentication means are included only as data for all registrants, is that the authentication performance of each authentication means are preserved as data for each registrant. Thereby, conditions for authentication, such as a best combination of a plurality of authentication and a threshold, may be selected every registrant, when authentication of persons is performed by specification of registrants with IDs and so on.

Then, log data of actual authentication are analyzed as well as the case shown in the authentication-selection system according to the above second embodiment, and the results of the above analysis may be reflected on the authentication performance of each authentication means. In this case, matching score for identical persons and FRR every registrant, and matching score for other persons and FAR are calculated, and a distribution of matching score for identical persons and FRR every existing registrant, and a distribution of matching score for other persons and FAR are updated. Thereby, a best authentication every specific registrant may be selected, using the distribution of matching score for identical persons, and the distribution of matching score for other persons based on the actual authentication results. Here, the distribution of matching score for other persons for specific registrants means matching score after mutual verification of data between the above registrants themselves, and other persons except the above registrants. And, in this case, the registrants who are objects for authentication are required to be previously specified.

Here, the reflection based on the above log analysis may be performed, whenever log data are increased, or when predetermined number of log data are accumulated. And, the above reflection may be performed at a predetermined time interval, for example, once a day. In addition, extraction of the input data from the log data may be performed for log data which are recorded after the previous processing. And, the log data which are mutually verified may be only new ones or data including old ones.

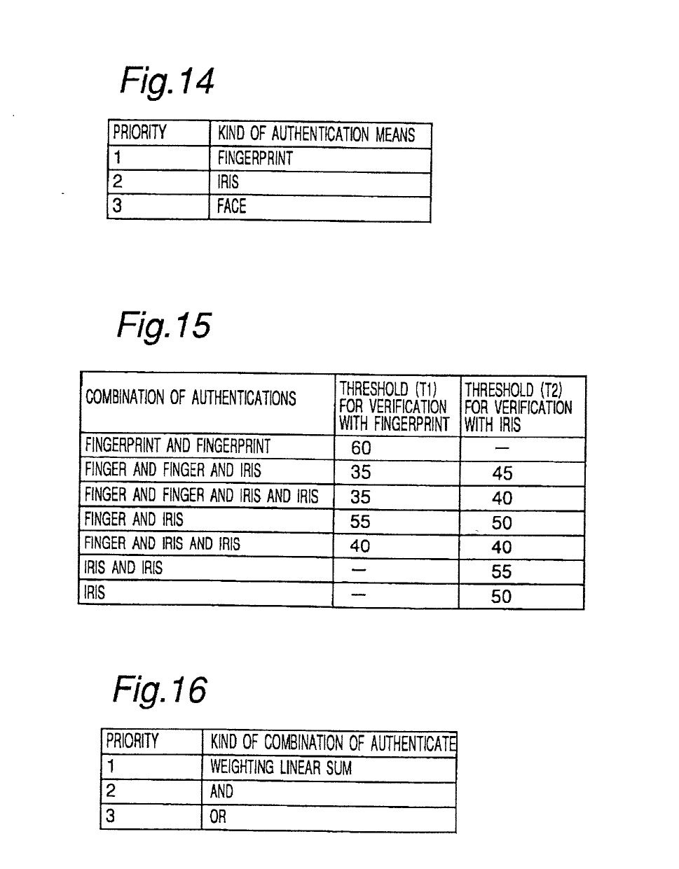

An authentication-selection system according to the fourth embodiment of the present invention will be described. A point of differences between the present authentication-selection system and that according to the first embodiment, is that the priority in the kinds of authentication means is set as a limiting condition, as shown in FIG. 14. As described in the above first embodiment, there is a case where there are a plurality of authentication or combinations of a plurality of authentication satisfying the target performance. In the above authentication-selection system, the priority in the kinds of the authentication means is configured to be set in a limiting-condition setter 22. Thereby, one suitable authentication or an adequate combination of a plurality of authentication may be selected. Here, the following items may be set as the above limiting condition: kinds of a plurality of authentication means; priority in the above kinds; a maximum number of authentication for combination; priority in the number of the above authentication for combination, methods for combining a plurality of authentication; priority in the above methods for combining the above authentication; a number of candidates for combinations of a plurality of authentication; and so on. And, with regard to the priority in the kinds of the authentication means, the priority may be respectively determined according to the characteristics of the kinds of authentication means, such as processing time, processing cost, using energy. In such a case, for example, a fingerprint with the shortest processing time has the first priority, a face the second one, and an iris the third one as the priority in the kinds of the authentication means based on the length of the processing time.

Subsequently, procedures for arrangement of each combination according to the priority in the kinds of the authentication means shown in FIG. 14 will be described below.

(1) In the first place, an authentication and a combination of a plurality of authentication are rearranged in an authentication-means selector 26, based on the priority, which is one of limiting conditions, in the authentication means of FIG. 14, when there are a plurality of candidates for a combination of a plurality of authentication. As the priority of the fingerprint is the highest as the priority in the authentication means of FIG. 14 in the above rearrangement, an authentication or a combination of a plurality of authentication comprising the fingerprint as authentication means is selected in the first place. Then, an authentication or a combination of a plurality of authentication comprising the iris, which is in the second rank in the priority, is selected. When there are relations, which are shown in FIG. 9A, between an authentication or a combination of a plurality of authentication and thresholds satisfying the target performance, rearrangement shown in the table of FIG. 15 is obtained.

(2) Then, an authentication or a combination of a plurality of authentication with the highest priority is selected as the final candidate with the CPU 13.

As described above, the priority in the kinds of the authentication means may narrow down to the final candidate.

An authentication-selection system according to the fifth embodiment of the present invention will be described. A point of differences between the present authentication-selection system and that according to the fourth embodiment, is that the priority in the methods (calculation method) for combining of a plurality of authentication and the priority in the number of combined authentication are set as limiting conditions. As described above, the above limiting conditions may narrow down to a suitable combination of a plurality of authentication, even when there are a plurality of combinations of a plurality of authentication satisfying the target performance.

Specifically, the above authentication-selection system sets, as shown in FIG. 16, the priority in the methods for combining a plurality of authentication as a limiting condition. The above limiting condition is set in a limiting-condition setter 22. When there are a plurality of candidate combinations of a plurality of authentication satisfying the target performance, the above candidate combinations are arranged in a authentication-means selector 26 according to the priority in the methods for combining a plurality of authentication shown in FIG. 16. As the priority of the weighting linear sum is the highest in the example of FIG. 16, combinations including weighting linear sum for combining a plurality of authentication may be selected in the first place, and, subsequently, a combination including the AND calculation with the second highest priority may be selected. As described above, the priority in the methods for combining a plurality of authentication may narrow down to the final candidate. Here, the number of a plurality of authentication for combination may be set as a limiting condition.

An authentication-selection system according to the sixth embodiment of the present invention will be described. A point of differences between the present authentication-selection system and the authentication-selection ones according to the first to fifth embodiments, is that the number of candidate combinations of a plurality of authentication for final selection is limited as a limiting condition. Thereby, a combination of a plurality of authentication may be promptly selected, as the above combination is selected within the set number of candidate combinations.

An authentication-selection system according to the seventh embodiment of the present invention will be described. A point of differences between the present authentication-selection system and that according to the first embodiment, is that the kind of authentication means which may be used may be automatically set beforehand by distinction of the authentication means connected to the system, in stead of setting of conditions for selection of the kind of authentication means as limiting conditions. Thereby, there is no need to previously input the kinds of the authentication means for selection as a limiting condition, and, even when there is a change in the authentication means, the changed authentication means may become an object for selection after automatic distinction of the above means. Here, the presence of sensors may be decided at distinction of the authentication means by operation of a fingerprint authentication device and so on as authentication means, and automatic distinction may be performed.

An authentication-selection system according to the eighth embodiment of the present invention will be described. A point of differences between the present authentication-selection system and the authentication-selection ones according to the above first to seventh embodiments, is that application of limiting conditions is performed stepwise in the case of selection of combinations of a plurality of authentication using authentication means in the authentication-means selector. Thereby, selection of a combination of a plurality of authentication is not performed at a time; limiting conditions different from each other are separately applied; and a totally suitable combination of a plurality of authentication may be selected. And, the selection may be performed by stepwise application of limiting conditions for narrowing down to a combination of a plurality of authentication.

According to the authentication-selection system of the present invention, there has been provided an authentication-means selector for selection of an authentication or a combination of a plurality of authentication, which meet target performance required for authentication. Thereby, authentication with high accuracy may be realized by suitable selection of an authentication or a combination of a plurality of authentication with high authentication performance.

And, according to the authentication-selection system of the present invention, there have been provided a combination generator for generation of an authentication or a combination of a plurality of authentication; and a combined authentication-performance calculator for calculation of authentication performance of the above generated authentication or the above generated combination of a plurality of authentication. Thereby, authentication performance of a combination of a plurality of authentication using a plurality of authentication means and so on may be obtained from the authentication performance of each authentication means. Thereby, a degree of improved accuracy in an authentication and a combination of a plurality of authentication may be estimated, and an authentication or a combination of a plurality of authentication, which are provided with required authentication performance, may be selected.

In addition, according to the authentication-selection system of the present invention, limiting conditions for authentication to be selected have been set. Thereby, an authentication or a combination of a plurality of authentication may be selected, based on the above limiting conditions, even when there are a plurality of combinations of a plurality of authentication satisfying target performance.

In addition, the kinds of authentication means and the priority in the above kinds have been set as limiting conditions according to the authentication-selection system of the present invention. Thereby, suitable an authentication or an appropriate combination of a plurality of authentication may be selected.

And, the authentication-selection system according to the present invention has analyzed the log data of actual authentication for reflection on the authentication performance of each authentication means. Thereby, suitable an authentication or an appropriate combination of a plurality of authentication may be selected according to actual authentication results.

In addition, the authentication-selection system according to the present invention has stored the authentication performance of each registrants in a performance storage device. Thereby, a more suitable combination of a plurality of authentication may be selected every registrant.

Moreover, the authentication-selection system according to the present invention may select any of the following items as authentication performance: a probability density function of matching score for identical persons for a case where persons are registrants themselves; a numerical table; a probability distribution; and parameters in the case of approximation by a normal distribution.

The authentication system according to the present invention has comprise: the above authentication-selection system; and at least one of authentication means for authentication of persons. Thereby, authentication with high accuracy using each authentication means may be performed by a suitable combination of a plurality of authentication selected by the above authentication-selection system.

According to the authentication-selection method of the present invention, an authentication or a combination of a plurality of authentication, which meets target performance required for authentication, has been selected. Thereby, persons may be authenticated with high accuracy by a selected authentication, or a selected combination of a plurality of combination.

According to the authentication method of the present invention, an authentication or a combination of a plurality of authentication, which meets target performance required for authentication, has been selected, and persons have been authenticated by the above selected authentication or the above selected combination of a plurality of authentication. Thereby, authentication may be performed with high accuracy.

According to the authentication program of the present invention, an authentication or a combination of a plurality of authentication, which meets target performance required for authentication, has been selected. Thereby, persons may be authenticated with high accuracy by a selected authentication, or a selected combination of a plurality of combination.

As a recording medium, which may read programs with a computer and has stored an authentication-selection program according to the present invention, is superior in portability, the above authentication-selection system may be easily operated on a computer.

According to the authentication program of the present invention, an authentication or a combination of a plurality of authentication, which meets target performance required for authentication, has been selected, and persons have been authenticated by a selected authentication, or a selected combination of a plurality of combination. Thereby, authentication with high accuracy may be realized.

As a recording medium, which may read programs with a computer and has stored an authentication-selection program according to the present invention, has been superior in portability, the above authentication-selection system may be easily operated on a computer.

Although the present invention has been described in connection with the preferred embodiments thereof with reference to the accompanying drawings, it is to be noted that various changes and modifications are apparent to those skilled in the art. Such changes and modifications are to be understood as included within the scope of the present invention as defined by the appended claims, unless they depart therefrom.

What is claimed is:

1. An authentication-selection system comprising:
a storage device storing an target-performance required for authenticating a person; and
an authentication-means selector which selects one among a plurality of authentication and one or more combinations of said authentication means satisfying said target-performance.

2. The authentication-selection system according to claim 1, further comprising:
a combination generator which generates a plurality of authentication and one or more combinations of said authentication means; and
a calculator which calculates authentication performance for each of said every said plurality of authentication and said one or more combinations of said authentication means.

3. The authentication-selection system according to claim 1, further comprising:
a target-performance setter which sets said target performance; and
a limiting-condition setter which sets limiting condition for authentication means,
wherein said combination generator generates said plurality of authentication and said one or more combinations of said authentication means, based on said limiting condition; and
wherein said authentication-means selector selects one among said plurality of authentication and said one or more combinations of said authentication means, based on said limiting condition.

4. The authentication-selection system according to claim 3, wherein said at least one limiting condition includes at least one of the following items:
a plurality of kinds of said plurality of authentication means;
a priority in said plurality of kinds of said plurality of authentication means;
a combination of said plurality of authentication;
priority in said combinations;
a number of said plurality of authentication for combination;
priority in the numbers of said authentication for combination; and
a number of candidate combinations.

5. The authentication-selection system according to claim 1, further comprising:
a performance storage device for storing the authentication performance of said authentication means; and
a log-analyzer for analyzing the log data which is authentication result by said authentication means, and for reflecting the analysis results on the authentication performance of said authentication means.

6. The authentication-selection system according to claim 5, wherein said performance storage device stores authentication performance for each registrant.

7. The authentication-selection system according to claim 1, wherein the authentication performance of said authentication means includes at least one of the following items:
a probability density function of matching score indicating degrees of coincidence between input data and registration data in a case where person is registrant;
a numerical table;
a probability distribution; and
parameter in the case of approximation by a normal distribution.

8. An authentication system comprising:
the authentication-selection system according to claim 1 for selecting one among a plurality of authentication and one or more combination of said authentication; and
at least one of a plurality of authentication means for authenticating person by verification of input data of persons with registration data,
wherein authentication of said person is performed by said selected authentication or said selected combination of said authentication.

9. A selecting method for selecting one among a plurality of authentication and one or more combinations of said authentication, said method comprising the steps of:
generating said one or more combination of said authentication using authentication means for authenticating person;
calculating and storing authentication performance for each of said plurality of authentication and said one or more combinations of said authentication; and
selecting one among said plurality of authentication and said one or more combinations of said authentication, which meets target performance required for authentication.

10. An authentication method comprising the steps of:
generating one or more combinations of said authentication, which is performed by said authentication means;
calculating and storing authentication performance for each of said plurality of authentication and said one or more combination of said authentication;
selecting one among said plurality of authentication and said one or more combinations of said authentication, which meets target performance required for authentication; and
authenticating a person after verification of input data of person with registration data by said authentication, or said combination of said authentication.

11. An authentication-selection program executed on a computer, said program comprising the steps of said selecting method for selecting one among a plurality of authentication and one or more combinations of said authentication according to claim 9.

12. A computer-readable recording medium including the authentication-selection program according to claim 11.

13. An authentication program executed on a computer, said program comprising the steps of said authentication method according to claim 10.

14. A computer-readable recording medium including the authentication program according to claim 13.
